(19) United States
(12) Patent Application Publication
(10) Pub. No.: US 2010/0042882 A1
(43) Pub. Date: Feb. 18, 2010

(54) Packet Retransmissions

(76) Inventor: David Randall, Hampshire (GB)

Correspondence Address: STAAS & HALSEY LLP, SUITE 700, 1201 NEW YORK AVENUE, N.W., WASHINGTON, DC, 20005, US

(21) Appl. No.: 12/308,804

(22) PCT Filed: Jun. 22, 2007
(86) PCT No.: PCT/GB2007/050352

§ 371 Date: Sep. 29, 2009

(30) Foreign Application Priority Data
Sep. 22, 2006 (GB) 0618902.1

(51) Int. Cl. H04L 1/18; G06F 11/14

(52) U.S. Cl. 714/748; 714/E11.113

(57) ABSTRACT

A method of packet retransmission in a communications system having a plurality of user devices and at least one network device involves broadcasting a multimedia broadcast multicast service transmission to the plurality of user devices. One or more of the user devices which failed to receive the complete transmission correctly send a request for retransmission to the network device and the network device retransmits requested packets of the original transmission on a different transmission channel to the original broadcast channel.

### CROSS REFERENCE TO RELATED APPLICATIONS

This application is based on and hereby claims priority to German Application No. 0612439.0 filed on Jun. 23, 2006 and International PCT Application No. PCT/GB2007/050352 filed on Jun. 22, 2007, the contents of which are hereby incorporated by reference.

### BACKGROUND OF THE INVENTION

This invention relates to a method of packet retransmission, in particular for universal mobile telecommunications system (UMTS). In cellular radio systems such as UMTS and global system for a mobile communications (GSM) there is a service class known as multimedia broadcast multicast service (MBMS) whereby information is transmitted to multiple user equipments (UEs), or user devices, using a common (broadcast) downlink channel. This form of transmission is referred to in UMTS as a point-to-multipoint channel. In UMTS, MBMS services can also be transmitted by way of a data channel that is dedicated to a particular UE, known as point-to-point (ptp) transfer.

When data is transmitted in a point-to-multipoint channel, the UEs that are receiving it can independently fail to correctly decode particular data blocks, sometimes known as PDUs, or transport blocks. There are a plurality of well-known methods for recovering from packet loss. One method is for an outer forward error correcting (FEC) code to be applied across multiple packets. The error correction capabilities of the FEC code can repair the packet loss in many circumstances. A second method is known as automatic repeat request (ARQ), whereby UEs request from the transmitting entity that packets that were not received should be repeated. ARQ has been applied to MBMS in GSM. In the GSM case, mobile stations (MS) that are receiving the service can be allocated an identifier that the network uses to poll the MS and in response the MS indicates the identities of packets, within a window, or range, of packet sequence numbers that it has failed to receive. The MS responds in a defined transmission interval associated with the poll. After collection of loss reports from multiple MSs, the identified packets can then be retransmitted by the transmitting entity. Retransmissions are made within the same transmission channel that was used for the original packet transmissions. The identities that the network assigns to the MS for the purpose of polling can be changed, or removed by the network. Up to sixteen MSs can be assigned identities at one time and MSs can request assignment of an identity after receiving notification on the MBMS control channel at session start, or when they enter a cell.

However, using the same transmission channel for retransmission increases complexity because the retransmission needs to be inserted into a common packet stream and the carrier capacity varies according to the level of demand for retransmission.

### SUMMARY

The inventor proposes a method of packet retransmission in a communications system, the system comprising a plurality of user devices and at least one network device, comprises broadcasting a multimedia broadcast multicast service transmission to the plurality of user devices; sending a request for retransmission to the network device from one or more of the user devices which failed to receive the complete transmission correctly; and retransmitting requested packets of the original transmission on a different transmission channel to the original broadcast channel. In the proposed method, the retransmissions are made on a different logical, transport or physical channel to the initial point-to-multipoint transmission on which the packets were first transmitted, thereby avoiding the problems encountered in existing GSM systems.

Preferably, the broadcast channel is an MBMS point to multipoint bearer. Preferably, the different transmission channel is a different logical, transport or physical channel to the broadcast channel.

Preferably, only certain predetermined categories of user device are permitted to request retransmission.

Preferably, the network device allocates user devices to the category of user device permitted to request retransmission, using signal strength and interference data reported by each user device.

Preferably, the network device sets a threshold for data reported by each user device, above which retransmission requests are not enabled.

Preferably, a proportion of the user devices below the threshold set by the network device make retransmission requests on periodically assigned dedicated resources.

Preferably, user devices make retransmission requests on contention access resources.

Preferably, the retransmissions are broadcast to a group comprising those user devices which have made a request for retransmission.

Alternatively, the retransmissions are made to individual user devices using hybrid automatic repeat request (HARQ).

### BRIEF DESCRIPTION OF THE DRAWINGS

These and other objects and advantages of the present invention will become more apparent and more readily appreciated from the following description of the preferred embodiments, taken in conjunction with the accompanying drawings of which:

FIG. 1 illustrates a cellular radio system in which UEs are receiving an MBMS transmission and make retransmission requests in the proposed method;

FIG. 2 shows an information flow diagram for an MBMS data transfer mechanism incorporating retransmission in the proposed method according to the present invention; and

FIG. 3 illustrates a signaling procedure to join a retransmission request reporting group for the proposed method.

### DETAILED DESCRIPTION OF THE PREFERRED EMBODIMENT

Reference will now be made in detail to the preferred embodiments of the present invention, examples of which are illustrated in the accompanying drawings, wherein like reference numerals refer to like elements throughout.

The proposed method relates to the channel used for making retransmissions and the method used to select a user equipment to report packet loss in an ARQ system, or HARQ system that repairs packet loss in an MBMS transmission system. It applies in particular to 3^{rd} generation partnership project (3GPP) cellular radio systems.

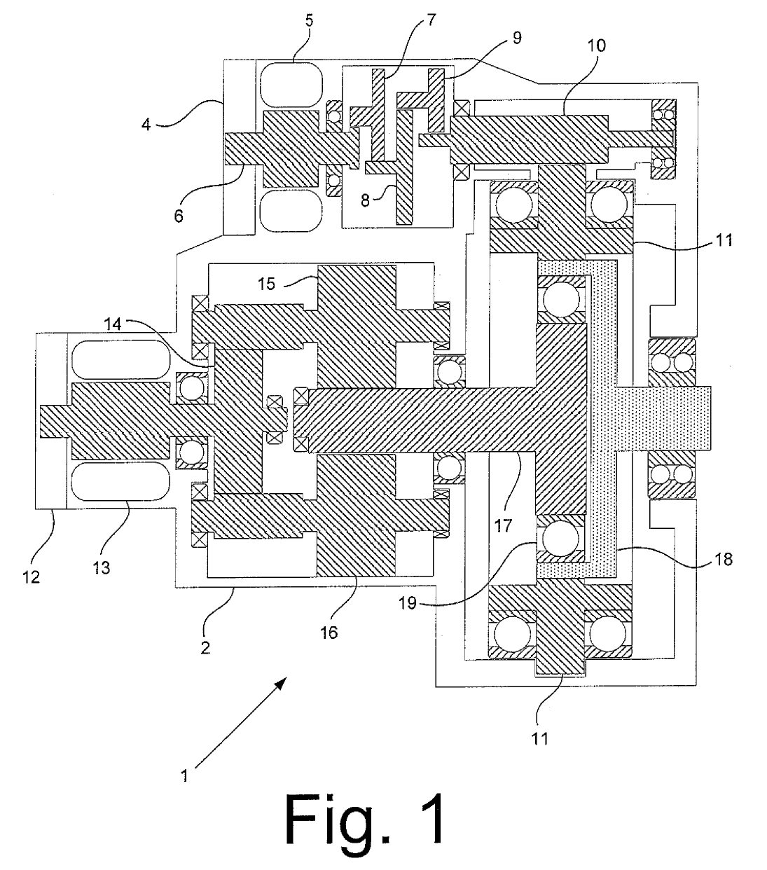

Retransmissions are made on a different transmission channel to the initial point-to-multipoint transmission. UEs which are receiving a service provide feedback in response to the transmission by indicating to the transmitting entity that they would like to receive a retransmission of particular packet or packets, also known as transport blocks, which they did not receive correctly. This indication may take the form of a negative acknowledge (NACK). Optionally, UEs which did receive the transmission correctly also provided feedback, by sending an acknowledge (ACK), so indicating that they do not require any retransmission. The packets that are needed can be identified by packet sequence numbers, or transport block sequence numbers, or by the radio frame sequence numbers of the radio frames in which the first transmission should have been received, which are applied at the transmitter. These can then be retransmitted by the transmitting entity. In one embodiment, only certain UEs, perhaps even none, are enabled to request retransmission. In another embodiment, all UEs are enabled to request retransmission. For any of these cases, the option of sending an ACK when receipt is successful may be set or not. The UEs that are enabled to request the retransmission of packets send their requests to the transmitter, either using dedicated (scheduled) resources, or on access resources shared by contention e.g. random access channel (RACH). For example, in the case of UMTS long term evolution (LTE) the retransmissions may be made using the downlink shared channel (DL-SCH); either in a broadcast mode without hybrid ARQ (HARQ) to all interested UEs, possibly using a group identifier; or individually to each UE using HARQ. When retransmissions are received by the UE, they may be combined in the physical layer with the corresponding transport block received with the first transmission as in HARQ, or alternatively, the first transmission for the block may be discarded and the content of the retransmission combined with packets received in the first transmission at a higher layer, e.g. at layer 2. FIG. 1 shows a cellular environment 1, including a base station, BI otherwise referred to in relation to UMTS LTE as eNB and a plurality of user devices illustrated here as mobile stations M1 to M4 which are otherwise known as UEs in the context of UMTS, or UMTS LTE. The base station BI transmits 2 an MBMS service to all of the MSs. M3 and M4 transmit retransmission requests 3, 4 to the base station BI whilst M1 and M2 do not.

The original MBMS transmission 2 is made by a point-to-multipoint bearer i.e. one that is being transmitted in a broadcast form so that it can be received by multiple UEs M1, M2, M3, M4 simultaneously, rather than one that is transmitted in a form that is specific to a UE i.e. point-to-point. The transmission may be made in a single cell without co-ordination with the transmissions made for the same service or session in neighbor cells (not shown). Alternatively, the transmission format of the original transmission 2 may be designed so that identical synchronized transmissions are made in a group of cells so that a UE receiving both a serving and one or more neighbor cells can combine the several transmissions to enhance the received signal quality. In a UMTS network this can be done by an MBMS technique, known as soft combining and in a UMTS LTE network, this is done as a single frequency network (SFN) transmission.

One or more UEs request retransmissions 3, 4 of packets that they failed to receive from a single (serving) cell and the serving cell arranges for these packets to be resent. The serving cell retransmits the requested packets using a different logical channel and/or transport channel and/or physical channel to that which was used to transmit the packets for the first time.

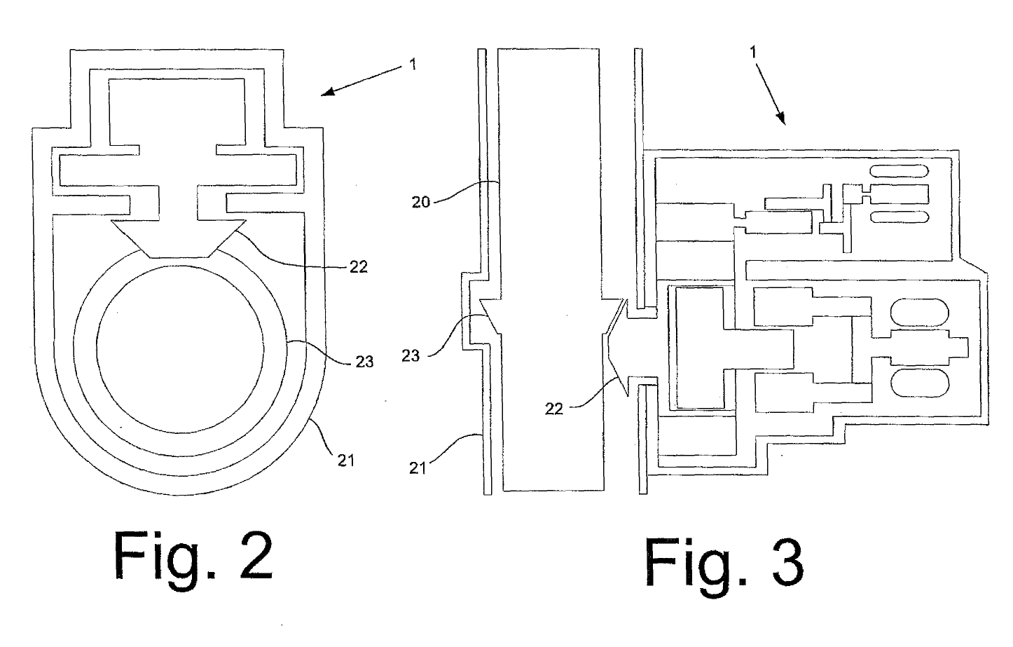

FIG. 2 shows a signaling exchange whereby a transmitter NB transfers data to a UE, the UE indicates that packets have been detected as missing and the transmitter resends the missing packets to the UE. The transmitter NB sends MBMS data 5, 6, 7 on one channel to the UE. The UE fails to receive some of this data correctly, so sends a retransmission request 8 to NB on a different channel. Further MBMS data 9 continues to be sent to the UE on the first channel and at a suitable point, the retransmitted MBMS data 10 is sent on a yet another channel. The transmitter continues to send original MBMS data 11, as required.

Where the original transmissions are SFN, or soft combined and as a result the transmissions in all cells within a cell group are substantially identical, then by making the retransmissions on a separate channel from that which is used for the original transmission, the complexity of inserting retransmissions, which are specific to a cell, into a packet stream that is common to several cells, is avoided. This is particularly true if the initial common transmission is formatted in a separate node e.g. radio network controller (RNC), to the node in which the retransmission is made e.g. Node B. Furthermore, the primary carrier carrying the first transmission can be maintained at a constant data rate, unchanged by the variable capacity that is required by the retransmissions if they are not sent on a different carrier. Also, since the retransmissions are made to a single UE, or a group of UEs that is smaller than that to which the original transmission was made, then better error protection, via error correcting coding or HARQ, possibly combined with a lower transmission power, can be used for the retransmissions. For example, the retransmissions can be made on a bearer that is dedicated to the UE, so that HARQ and power control techniques can be applied. Alternatively, where the transmission is to be transmitted to a group of UEs, more powerful coding may be applied.

As an example of the application specifically to UMTS LTE, the first transmission may be made via an MBMS point to multipoint traffic channel (MTCH) logical channel mapped to a multicast channel (MCH) transport channel that is, in turn, mapped to a set of physical resources. The first transmission may be SFN or non-SFN, and the retransmissions can be made by a second MTCH mapped to an MCH, or to the downlink synchronization channel (DL-SCH), which is mapped to a different set of physical resources to those used for the first transmission. This can be made accessible to any UE that chooses to receive the transmission and may contain the aggregate of all packets that were requested by all UEs that requested retransmissions, or each requested packet/transport block may be sent separately to enable combining at the physical layer. Alternatively, the retransmissions may be made separately to each UE that requested them, using a dedicated traffic channel (DTCH) logical channel mapped to the DL-SCH transport channel. These point-to-point transmissions make use of HARQ.

UEs can be subdivided into a group that can request retransmissions, for example using ARQ and a group that cannot request retransmissions, or can only request on contention access channels. The UEs that are enabled to request retransmissions can be selected by the network based on their signal strength and interference environment, possibly identified via measurement reports made by the UE. For example, UEs on the cell boundary may be enabled to make retransmission requests. In the variation where UEs are permitted (enabled/disabled by network control signaling) to make retransmission requests on contention access resources e.g. RACH, a fraction of the UEs in a cell may be enabled to make retransmission requests via dedicated resources e.g. periodically assigned resources, if the UEs are in poor radio conditions. With this, load on the RACH is reduced. Requests for retransmissions can be made periodically throughout the MBMS transmission or, for example in the case of a transmission of short duration, at the end of the transmission.

The action of UEs making uplink retransmission requests consumes uplink resources and so it is desirable that the load on uplink resources is managed. For those UEs that are located close to a transmitter, the signal to interference level may be good enough for the packet loss rate to be low. For these UEs, disallowing retransmission requests, or alternatively permitting their transmission on a contention access resource, such as RACH may be sufficient.

For UEs which are located in poor signal to interference environments, such as might exist on a cell boundary, the rate at which packet loss occurs is likely to be much higher. In these circumstances, it can be more efficient for the use of uplink resources if defined uplink resources are assigned to each UE, so that their uplink transmissions can be controlled. For example, a UE reports a plurality of packet identities in one transmission, or as alternative to dedicated resources, these UEs may make use of contention access uplink resources e.g. RACH, provided that the number of UEs that can report by this mechanism is limited in number.

Therefore, it is preferable that the total number of UEs in a cell that are receiving an MBMS transmission and can make retransmission requests is separated into two groups, one that is not permitted to make retransmission requests and one that is permitted to make retransmission requests, either by contention access e.g. RACH or UE dedicated resources depending upon implementation. A second option is that the first group is permitted to make retransmission requests by contention access resources and the second group by dedicated resources. The subdivision of UEs into the two groups is controlled by control signaling transmitted by the serving eNB.

In one example the control signaling, transmitted for example on the MBMS control channel (MCCH), identifies a threshold parameter, for example path loss measured on the cell pilot, or signal to interference ratio, or MBMS transmission packet loss rate. If the threshold is crossed for a UE, this enables the UE to request to join the second group which can make retransmission requests. The network then assigns the UE uplink resources and/or an MBMS specific identifier that enables retransmission requests to be made. By default, a UE is in the first group, which is not permitted to make retransmission requests. This embodiment is applicable to the cases of UEs that are in the LTE radio resource control (RRC)-Idle state or the LTE RRC-Connected state.

In a second example, the network decides to include a UE in the first, or second group above based on measurement reports that the UE makes. Based on measurements of path loss, or signal to interference ratio, the network (eNB) chooses to assign a UE to the first group, or the second group based on these measurement reports. This embodiment is applicable to UEs that are in the LTE RRC-Connected state.

In both of these embodiments, the network may remove UEs from the second group, signaling to them that they are released from the second group, if one of the following occurs: reports of path loss, measured on a cell transmission such as a pilot, made by the UE to the network show the path loss has fallen below a threshold; reports of signal to interference measurements rise above a threshold; the number of retransmission requests made by the UE in a time period falls below a threshold. Alternatively, these rules are applied in the UE and the UE requests release when they occur.

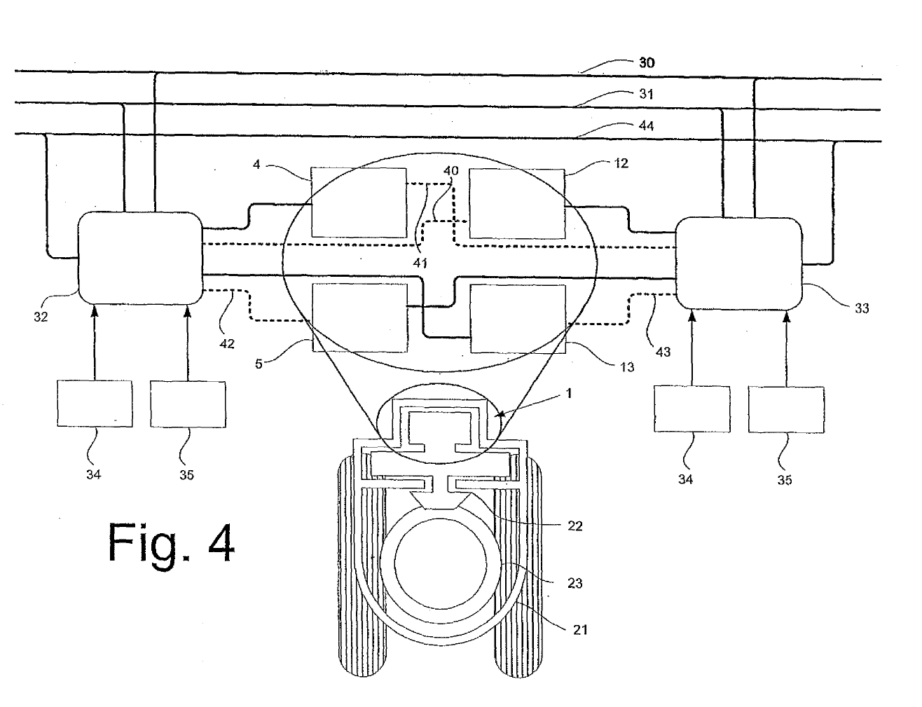

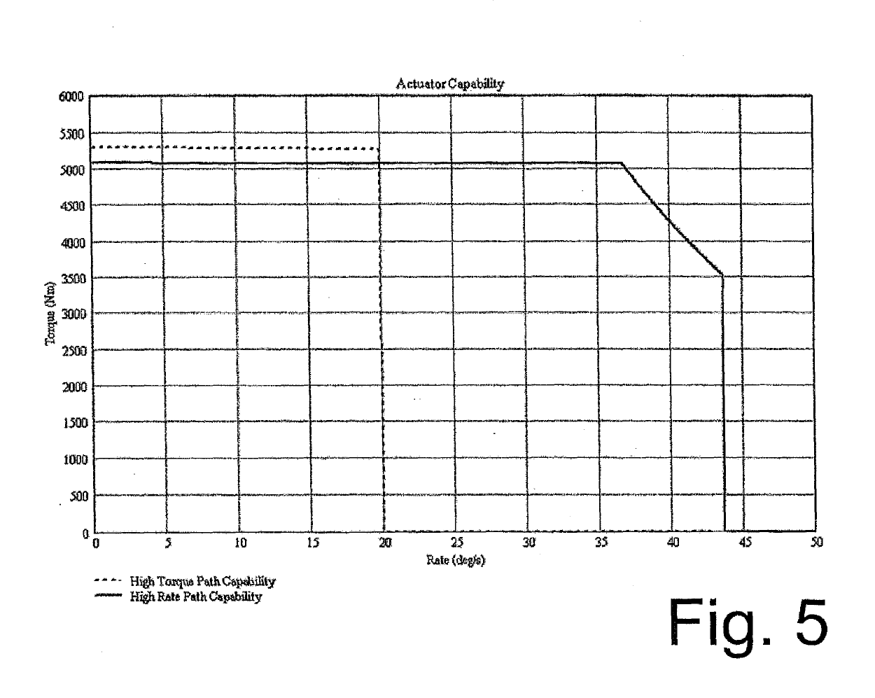

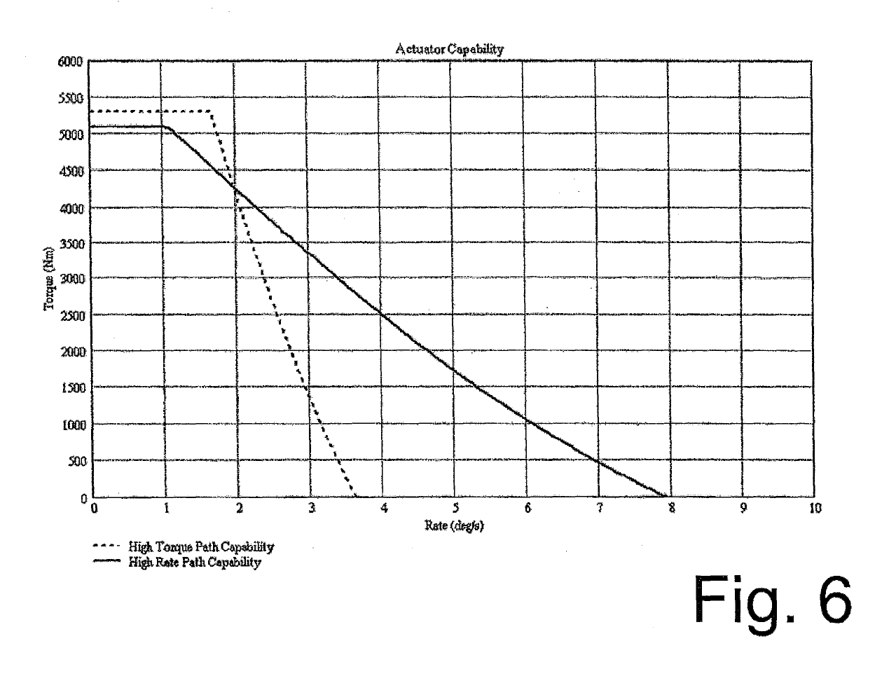

FIG. 3 shows a signaling exchange relating to retransmission request reporting groups. A network device NB sends MBMS retransmission join criteria 12 which set out rules regarding whether a UE should apply to join the retransmission reporting group for a service, the UE requests to join by sending an MBMS retransmission join request 13 and is assigned parameters by the network device which enables the UE when it receives the join grant 14 to transmit.

The invention has been described in detail with particular reference to preferred embodiments thereof and examples, but it will be understood that variations and modifications can be effected within the spirit and scope of the invention covered by the claims which may include the phrase “at least one of A, B and C” as an alternative expression that means one or more of A, B and C may be used, contrary to the holding in Superguide v. DIRECTV, 69 USPQ2d 1865 (Fed. Cir. 2004).

1-10. (canceled)

11. A method of packet retransmission in a communications system having a plurality of user devices and at least one network device, the method comprising:
broadcasting a multimedia broadcast multicast service transmission to the plurality of user devices, the multimedia broadcast multicast service transmission being broadcast on an original broadcast channel from the network device;
sending a request for retransmission to the network device from one or more of the user devices which failed to completely and correctly receive the multimedia broadcast multicast service transmission, the request specifying requested packets for retransmission; and
retransmitting the requested packets of the multimedia broadcast multicast service transmission on a different transmission channel from the original broadcast channel.

12. A method according to claim 11, wherein the original broadcast channel is an MBMS point to multipoint bearer.

13. A method according to claim 11, wherein the different transmission channel is a different logical, transport or physical channel from the original broadcast channel.

14. A method according to claim 11, wherein only a certain predetermined category of user devices are permitted to request retransmission.

15. A method according to claim 14, wherein the network device determines which devices are permitted to request retransmission based on signal strength and interference data reported by each user device.

16. A method according to claim 15, wherein
the network device sets a threshold for the signal strength and interference data reported by each user device, and
if a user device reports the signal strength and interference data above the threshold, a retransmission request is not enabled for the user device.

17. A method according to claim 16, wherein
user devices are permitted to request retransmission only periodically such that, at any one instant only a proportion of the user devices below the threshold set by the network device make retransmission requests, and
the requests for retransmission are made on periodically assigned dedicated resources.

18. A method according to claim 11, wherein user devices make retransmission requests on contention access resources.

19. A method according to claim 11, wherein retransmissions are broadcast to a group comprising those user devices which have made a request for retransmission.

20. A method according to claim 11, wherein the requested data packets are retransmitted to individual user devices using hybrid automatic repeat request.

21. A method according to claim 12, wherein the different transmission channel is a different logical, transport or physical channel from the original broadcast channel.

22. A method according to claim 21, wherein only a certain predetermined category of user devices are permitted to request retransmission.

23. A method according to claim 22, wherein the network device determines which devices are permitted to request retransmission based on signal strength and interference data reported by each user device.

24. A method according to claim 23, wherein
the network device sets a threshold for the signal strength and interference data reported by each user device, and
if a user device reports the signal strength and interference data above the threshold, a retransmission request is not enabled for the user device.

25. A method according to claim 24, wherein
user devices are permitted to request retransmission only periodically such that, at any one instant only a proportion of the user devices below the threshold set by the network device make retransmission requests, and
the requests for retransmission are made on periodically assigned dedicated resources.

26. A method according to claim 25, wherein user devices make retransmission requests on contention access resources.

27. A method according to claim 26, wherein retransmissions are broadcast to a group comprising those user devices which have made a request for retransmission.

28. A method according to claim 26, wherein the requested data packets are retransmitted to individual user devices using hybrid automatic repeat request.

29. A network device in a communications system having a plurality of user devices, the network device comprising:
a first transmitter unit to broadcast a multimedia broadcast multicast service transmission to the plurality of user devices, the multimedia broadcast multicast service transmission being broadcast on an original broadcast channel;
a receiver to receive a request for retransmission of failed data packets from one or more of the user devices which failed to completely and correctly receive the multimedia broadcast multicast service transmission;
a second transmitter unit to retransmit the failed packets of the multimedia broadcast multicast service transmission on a different transmission channel from the original broadcast channel; and
a setting unit to set a threshold for signal strength and interference experienced by the user devices, such that if a user device experiences signal strength and interference above the threshold, a retransmission request is not enabled for the user device.
